(19) United States
(12) Patent Application Publication
(10) Pub. No.: US 2004/0211108 A1
(43) Pub. Date: Oct. 28, 2004

(54) Fishing rod

(75) Inventor: Naoyuki Ezuka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: DAIWA SEIKO, INC.

(21) Appl. No.: 10/787,130

(22) Filed: Feb. 27, 2004

(30) Foreign Application Priority Data
Feb. 28, 2003 (JP) P2003-054509
Feb. 28, 2003 (JP) P2003-054510

(51) Int. Cl. A01K 87/00

(52) U.S. Cl. 43/18.1 R

(57) ABSTRACT

A fishing rod includes: a rod pipe; a tubular body to which the rod pipe is inserted and fitted; a tubular transparent synthetic resin body integrally molded with the tubular body; and a concealing film formed at least one edge face portion of the synthetic resin body.

### BACKGROUND OF THE INVENTION

The present invention relates to a fishing rod fitted with parts such as a reel-leg fixing seat.

As referred to in JP-A-9-275858, there has been proposed a grip structure in which a grip for a fishing rod is formed by mating and covering the outer periphery of a rigid tubular body with a tubular member made of translucent elastic material. With the fishing rod in the grip structure like this, a pattern on the outer surface of the tubular body can be seen through the outside of a grip member.

When a load is applied to the tubular member made of elastic material of the grip structure, the quantity of deformation of the rigid tubular body differs from that of the elastic grip member and the elastic tubular member is deformed to a greater extent. Therefore, a gap is produced between the elastic tubular member and the rigid tubular body, which allows dust and water to readily penetrate into the gap. The dirt introduced into the gap is seen from the outside and the drawback is that the external appearance is deteriorated.

Japanese Patent No. 3,068,726 discloses a fishing rod having a slide groove in the form of a depression provided in a leg receiving hood, and a key to be mated with the slide groove, so that the leg receiving hood is fixed by the key to the fishing rod. Thus, it is feasible to reduce the weight and size of a reel-leg fixing seat by setting up such a reel-leg fixing seat structure that the leg receiving hood is directly fixed to the fishing rod.

The reel-leg fixing seat disclosed in Japanese-Patent No. 3,068,726 is a system of joining the leg receiving hood and the fishing rod by means of the key. Consequently, strength of members of both the leg receiving hood and fishing rod is lowered. Moreover, stress is concentrated on the joint portion by the key and the strength of mounting and fixing the leg receiving hood to the fishing rod is also lowered. Thus, the conventional reel-leg fixing seat structure not only renders the strength of mounting the reel-leg fixing seat weak but fails to secure the reel leg with stability.

An object of the invention made with attention directed to the problem above is to provide a fishing rod making the strength of fixedly mounting parts to a rod pipe improvable and stabilizable and also making the weight and site of a parts mounting portion reducible together with offering an excellent external appearance.

### SUMMARY OF THE INVENTION

An object of the invention made with attention directed to the problem above is to provide a fishing rod so that the external appearance of mounting parts fixed to its rod pipe is not only improved but stabilized.

Another object of the invention made with attention directed to the problem above is to provide a fishing rod making the strength of fixedly mounting parts to a rod pipe improvable and stabilized and also making the weight and size of a parts mounting portion reducible together with offering an excellent external appearance.

In order to accomplish the object above, a fishing rod according to the invention is provided such that a transparent synthetic resin body is formed by molding integrally with the outer side of a tubular body to form an integral member; a film having concealing properties is formed in at least one edge face portion of the synthetic resin body; and a rod pipe is fitted into and covered with the tubular body to which the integral member is mounted.

In order to solve the aforesaid object, the invention is characterized by having the following arrangement.

(1) A fishing rod comprising:

a rod pipe:

a tubular body to which the rod pipe is inserted and fitted;

a tubular transparent synthetic resin body integrally molded with the tubular body; and

a concealing film formed at least one edge face portion of the synthetic resin body.

(2) The fishing rod according to (1), wherein the tubular body is formed by winding fiber-reinforced prepreg prepared by impregnating reinforced fiber with synthetic resin, and an outer peripheral surface of the tubular body is visually confirmable from an outside of the synthetic resin body.

(3) The fishing rod according to (2) further comprising a cover member provided for covering a portion of the synthetic resin body where the concealing film is formed. p0 (4) The fishing rod according to (1), wherein the synthetic resin body includes an opening to which a leg of a reel is adapted to be inserted.

(5) The fishing rod according to (1), wherein a plane of the concealing film is inclined with respect to the tubular body.

(6) A method of manufacturing a fishing rod comprising the steps of:

molding a tubular transparent synthetic resin body integrally with a tubular body;

forming a concealing film on at least one edge face portion of the synthetic resin body; and

inserting and fitting a rod pipe to the tubular body with which the synthetic resin body is integrally formed.

(7) A fishing reel comprising:

a rod pipe;

a reinforced tubular body to which the rod pipe is inserted and fitted; and

a synthetic resin body which is integrally molded with an outer side of the tubular body, includes a portion larger in thickness than the tubular body and is made of a material softer than that of the tubular body.

(8) The fishing reel according to (7), wherein one end of the reinforced tubular body is projected from one edge face of the synthetic resin body in an axial direction of the tubular body.

(9) The fishing reel according to (7), wherein one end of the reinforced tubular body is located inside the synthetic resin body.

(10) The fishing rod according to (7), wherein the reinforced tubular body is formed by winding fiber-reinforced prepreg prepared by impregnating reinforced fiber with synthetic resin.

(11) The fishing rod according to (7) further comprising a member formed of soft material equal to or greater in softness than the material of the synthetic resin body which is disposed from one edge face of the synthetic resin body over an outer periphery of the rod pipe.

(12) The fishing rod according to (7) further comprising a concealing film formed in an end portion of the synthetic resin body; and a cover member for covering the film, wherein the synthetic resin body is made of a translucent material.

(13) The fishing rod according to (7), wherein the synthetic resin body includes an opening to which a leg of a reel is adapted to be inserted.

(14) A method of manufacturing a fishing rod comprising the steps of:

molding a synthetic resin body integrally with a tubular body so that a portion of the synthetic resin body is larger in thickness than the tubular body, the synthetic resin body being made of a material softer than that of the tubular body; and

inserting and fitting a rod pipe to the tubular body with which the synthetic resin body is integrally formed.

### BRIEF DESCRIPTION OF THE DRAWINGS

FIG. 1 is a vertical sectional view of part of a fishing rod according to a preferred embodiment of the invention.

FIG. 2 is a vertical sectional view of part of a fishing rod according to another preferred embodiment of the invention.

FIG. 3 is a bottom view of part of a fishing rod according to still another preferred embodiment of the invention.

FIG. 4 is a vertical sectional view of part of a fishing rod according a further preferred embodiment of the invention.

### DETAILED DESCRIPTION OF PREFERRED EMBODIMENTS

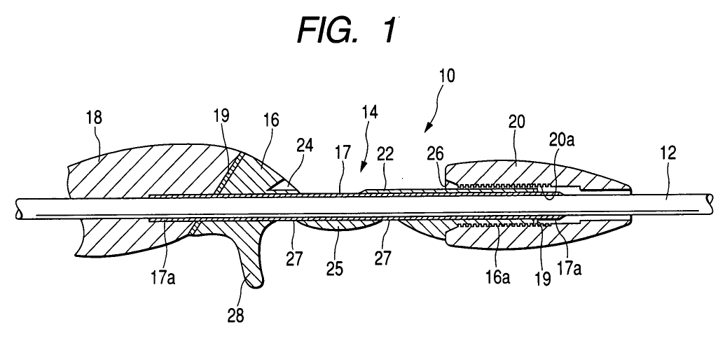

FIGS. 1 to 4 show a fishing rod according to the preferred embodiment of the invention. As shown in FIG. 1, a fishing rod 10 according to this embodiment of the invention includes a rod pipe 12 made of a fiber-reinforced synthetic resin forming a butt rod on the butt side, and a handle portion 14 fitted to the butt section of the rod pipe 12. The cylinder-shaped rod pipe 12 is formed normally by winding a sheet of prepreg on the outer periphery of an mandrel one over another, calcining the prepreg and pulling out the mandrel.

The handle portion 14 include a seat body 16 as a body member to which a fishing reel (not shown) is mounted and a rear-grip portion 18 formed behind the seat body 16, that is, formed integrally with the rod base portion. The seat body 16 is formed by injection molding using an injection molding means, for example, integrally with the outer side of a reinforced tubular body 17 covering and fitted to the rod pipe 12. The seat body 16 and the tubular body 17 form an integral member, and which makes the reinforced tubular body 17 fixedly adhere to the outer side of the rod pipe 12. The seat body 16 as a rod pipe part is made of transparent synthetic resins visually confirmable from the outside. The reinforced tubular body 17 is preferably made of material greater in rigidity than the seat body 16 or of high-strength material.

The rear grip portion 18 is provided at the rear end of the seat body 16 in series. The member of the rear grip portion 18 is formed of material equal to or greater than, in softness, the material of the seat body 16 and forms an outer surface continuous to the outer peripheral face of the seat body 16. The rear grip portion 18 is mounted and fixed to the rod pipe 12 passed therethrough and to the outer peripheral surface of the tubular body 17 with an adhesive agent, for example. As shown in FIG. 1, the seat body 16 is mounted and fixed to the rear grip portion 18 via a contact surface inclined toward the rod pipe 12. In this case, the adhesive method is not limited to the adhesive agent but may include press-fitting and so forth as suitable method.

A film 19 having concealing properties is interposed between the seat body 16 and the rear grip portion 18 so that the rear grip portion 18 covers the film 19. It is desirable that the film 19 is formed on the rear edge face of the seat body 16 beforehand in advance whereby to mount and fix the rear grip portion 18 to the outer surface of the film 19. As a method of forming the film 19 on the rear edge face of the seat body 16, painting, printing and plating, for example, is conceivable. Moreover, another film 19 having concealing properties is also formed on the front edge face of the seat body 16.

A threaded portion 16a is formed in the outer periphery of the front-end-side portion of the seat body 16. A cylindrical front grip portion (nut) 20 functioning as a moving hood mates with the threaded portion 16a. A threaded portion 20a mating with the threaded portion 16a of the seat body 16 is formed on the inner surface of the front grip portion 20. The front grip portion 20 is made movable on the seat body 16 in the axial direction by rotating the front grip portion 20.

The seat body 16 includes a reel leg placing-holding portion 22 for placing and holding a reel mounting leg portion (not shown) on one side of the intermediate portion of the seat body 16. A fixed hood provided with an opening 24 directed to a rod tip side is formed in the vicinity of the rear end of the reel leg placing-holding portion 22, the opening 24 being capable of receiving and latching the rear end portion of the leg portion for mounting the reel (not shown). Further, an opening 26 directed to the rod base side in the form of an inclined surface expanding in diameter to the rear end side over the whole periphery is formed in the inner peripheral portion of the rear end side of the front grip portion 20. The front end portion of the fishing-reel mounting leg portion is fitted in between the opening 26 and the outer peripheral surface of the seat body 16. The reel mounting leg portion is placed and held on top of the reel leg placing-holding portion 22 of the seat body 16 and, the front grip portion 20 is moved backward in a state that opposite end portions of the reel mounting leg portion are inserted and held in the respective openings 24 and 26 so that the reel mounting leg portion is clamped and fixed onto the reel leg placing-holding portion 22.

A trigger 28 is formed in and projected from the vicinity of the rear end portion where the opening 24 is formed, that is, the trigger 28 being projected from a side opposite to the diametrical direction of the reel leg placing-holding portion 22. In a place positioned ahead of the trigger 28, that is, in a place opposite to the diametrical direction of the reel leg placing-holding portion 22, a depression 27 is formed in front and behind a curved protrusion 25 according to the illustrated embodiment of the invention in order to facilitate so-called “palming” performed by manually gripping the whole reel tightly. The vicinity of the opening 24 as well as the trigger 28 is formed into a wide structure extended sideways and the intermediate portion of the seat body 16 is substantially flat in cross section. The depressions 27 may be formed such that they are opened out until the surface of the reinforced tubular body 17 is exposed outside.

The member of the seat body 16 according to this embodiment of the invention is made of synthetic resin having transparency such as nylon, polycarbonate, acryl, urethane or the like, for example, and the inner part of the seat body 16 is transparent to the extent that it is visually confirmable from the outside. As long as the transparent synthetic resin material for use in forming the seat body 16 as a transparent rod pipe part is such that its inner part is visually confirmable, the material may be not only transparent and colorless but transparent and colored including having a chromatic color. Moreover, the seat body 16 may be formed of not only such transparent synthetic resin material having a translucency percentage of close to 100% but semitransparent synthetic resin material having a translucency percentage of about 50%; or otherwise the seat body 16 may be divided into a plurality of portions formed of different materials, respectively.

Further, the seat body 16 may be made of transparent synthetic resin containing bubbles or partially decorated such that the trigger-side outer peripheral portion of the seat body 16 is decorated. In case that the vicinity of the trigger 28 in particular is formed into the wide structure extended sideways when seen from the side of the reel leg placing-holding portion 22, the decorated surface becomes visually confirmable through the transparent material of the seat body 16.

The material of the tubular body 17 can be made of fiber-reinforced synthetic resins (FRP), fiber-reinforced metals (FRM), metal materials, ceramic materials, carbon materials and so forth, and especially fiber-reinforced synthetic resins (FRP) in particular are preferred. Moreover, the material of the rear grip portion 18 can be made of EVA, natural cork, natural rubber, synthetic rubber, ABS, polyamide, synthetic resins, urethane, aluminum, ceramics, natural wood, reinforced wood and so forth.

According to this embodiment of the invention, an external appearance offering profundity and solidity is obtained from the translucent synthetic resin seat body 16 and the external appearance of the end portion of the synthetic resin seat body 16 is improved as the film 19 having concealing properties is formed in the edge face portion of the synthetic resin seat body 16. As the transparent seat body 16 is formed integrally with the reinforced tubular body 17 by molding, the reinforced tubular body 17 is stuck and fixed to the transparent synthetic resin seat body 16, so that water and dust are prevented from penetrating into the gap therebetween. Thus, the transparent external appearance of the synthetic resin seat body 16 as viewed from the outside is maintained in a good condition. Moreover, the synthetic resin seat body 16 is formed integrally with the outer side of the reinforced tubular body 17 by molding and the reinforced tubular body 17 is fixed to the rod pipe 12, whereby the synthetic resin seat body 16 can be secured firmly to the rod pipe 12. Particularly since the synthetic resin seat body 16 is not bonded to the reinforced tubular body 17 but formed integrally with the reinforced tubular body 17 by molding, the reinforced tubular body 17 externally looks beautiful when seen from the outside of the transparent synthetic resin seat body 16. The reinforced tubular body 17 is fixedly secured to the rod pipe 12 with an adhesive agent and the adhered portion between the rod pipe 12 and the reinforced tubular body 17 is not seen from the outside of the transparent synthetic resin seat body 16, so that as only the external appearance of the reinforced tubular body 17 is seen from the outside, the reinforced tubular body 17 still looks beautiful.

The film 19 formed in the edge face portion of the synthetic resin seat body 16 comes in close contact with the synthetic resin seat body 16 and integral therewith, whereupon the film 19 can maintain the close contact condition between the film 19 and the synthetic resin seat body 16 even though the synthetic resin seat body 16 is deformed. Thus, water, dust and the like are prevented from penetrating in between the synthetic resin seat body 16 and the film 19 and the good transparent external appearance can be maintained for a long term, accordingly. Even if a gap is produced between the synthetic resin seat body 16 and the rear grip portion 18 and even if water, dust and the like are allowed to penetrated into the gap, the gap portion is not seen from the side of the transparent synthetic resin seat body 16 because of the film portion 19 and the good external appearance as seen from the side of the synthetic resin seat body 16 can be maintained for a long term.

Since the reinforced tubular body 17 is formed by winding up the fiber-reinforced prepreg prepared by impregnating reinforced fiber with synthetic resin to make the surface of the tubular body visually confirmable, the reinforced tubular body 17 can be formed so as to have the external appearance of the fiber-reinforced material like the rod pipe 12, whereby the reinforced tubular body 17 can externally be designed to have a feeling integral with the rod pipe 12. The reinforced tubular body 17 is made of fiber-reinforced material and this results in improving the strength of a reel-leg fixing device.

Further, the rear grip portion 18 is provided as a cover member for covering the portion of the film 19 formed in the end portion of the synthetic resin seat body 16. Consequently, the film 19 having concealing properties is protected by the cover member, so that a beautiful transparent external appearance offering profundity and solidity can be maintained for a long term.

The synthetic resin seat body 16 together with the reinforced tubular body 17 is formed by insert molding on the outer side of the reinforced tubular body 17 which is mounted to the rod pipe 12 so as to cover and mate with the rod pipe 12. Therefore, fishing rod parts including the synthetic resin seat body 16 is easy to fabricate in comparison with a case where the member of the synthetic resin seat body 16 is directly formed on the outer side of the rod pipe 12. Moreover, a percentage of rejects is minimized. In case that inferior goods are produced after synthetic resin seat bodies 16 are manufactured by directly molding them on the outer side of each rod pipe 12, the whole product in progress including the expensive rod pipes 12 will have to be disposed of and this is uneconomical. According to this embodiment of the invention, however, the synthetic resin seat body 16 is formed integrally with the reinforced tubular body 17 to assemble a group of parts into a unit beforehand and the unit is mounted to the rod pipe 12, whereby the number of inferior goods is decreased, which results in reducing the manufacturing cost.

As the synthetic resin seat body 16 is mounted to the fiber-reinforced synthetic resin rod pipe 12 via the reinforced tubular body 17, the synthetic resin seat body 16 can be reinforced by the reinforced tubular body 17, whereby the strength of the fishing rod 10 is improved and stabilized. Moreover, the body member is reinforced by the reinforced tubular body 17 and moreover the synthetic resin seat body 16 is integrally formed by molding (without the use of an adhesive agent); thus, it is possible to provide a small-sized lightweight fishing rod while the fishing rod is restrained from growing larger in size.

The end portion of the reinforced tubular body 17 is projected and made longer than one edge face of the synthetic resin seat body 16 to form a projected portion 17a, whereupon stress is prevented from concentrating on the rod pipe 12 at the position of the and portion of the synthetic resin seat body 16, whereby the strength of the fishing rod 10 can be improved and stabilized. Moreover, the synthetic resin seat body 16 is set greater in thickness than the reinforced tubular body 17 and is made of a (soft) material smaller in rigidity, whereby the stress concentration developed on the rod pipe 12 at the position of the end portion of the seat body 16 is eased and it can be attempted to improve and stabilize the strength of the fishing rod 10 further.

As the rear grip portion 18 formed of soft material equal to or greater in softness than the material of the synthetic resin seat body 16 is disposed from one edge face of the synthetic resin seat body 16 over the outer periphery of the rod pipe 12 including the projected portion of the reinforced tubular body 17, no stress is concentrated on the vicinity of the end portion of the synthetic resin seat body 16 to ensure that the rod pipe 12 is prevented from being damaged from the vicinity of the end portion thereof.

The reinforced tubular body 17 is formed of the fiber-reinforced material prepared by winding up the prepreg to ensure that the adhesion and fastening of the rod pipe 12 to the reinforced tubular body 17 is strengthened. Particularly, even though the thickness of the synthetic resin seat body 16 in the circumferential direction varies or is odd-shaped, the roundness or tubularity of the synthetic resin seat body 16 is improved by the reinforced tubular body 17 and the adhesive agent uniformly spreads between the synthetic resin seat body 16 and the outer peripheral face of the rod pipe 12 so as to obtain stable fixing strength. Particularly, the synthetic resin seat body 16 during the molding process is subject to deformation at the time of thermal shrinkage of the synthetic resin layer and the inner hole is easily deformed into an elliptic shape or collapsed, Consequently, roundness is maintained and the adhesive agent is uniformly charged in, so that stable adhesive strength is obtained since the reinforced tubular body 17 is employed. Moreover, the deformation of the reel seat portion of the synthetic resin seat body 16 is suppressed by the reinforced tubular body 17.

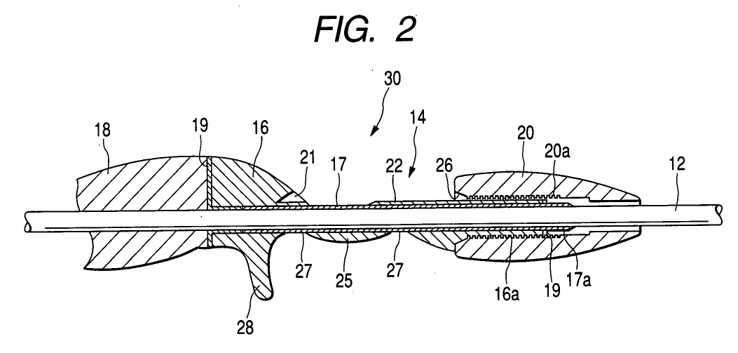

FIG. 2 shows a fishing rod as a modified example of the above-described embodiment of the invention. A fishing rod 30 in this modified example is different in that the rear end of the reinforced tubular body 17 is drawn inward from the rear end of the synthetic resin seat body 16 as a synthetic resin body member into the inner part of the synthetic resin seat body 16 to make shorter the reinforced tubular body 17; the film 19 is formed such that it is drawn in up to the rear end of the reinforced tubular body 17 drawn into the synthetic resin seat body 16; and the boundary plane between the synthetic resin seat body 16 and the rear grip portion 18 is not inclined with respect to the rod pipe 12 but forms a contact surface at right angles with respect to the rod pipe 12. However, as the rest of the arrangement other than the aforementioned is basically similar to the above-described embodiment of the invention, the detailed description thereof will be omitted.

In this modified example, the rear end of the reinforced tubular body 17 in its axial direction is made shorter than one end of the synthetic resin seat body 16, and the synthetic resin seat body 16 is made of a material greater in thickness and smaller in rigidity than the reinforced tubular body 17, whereby stress is prevented from concentrating on the rod pipe 12 at the position of the end portion of the synthetic resin seat body 16. Accordingly, it can be attempted to improve and stabilize the strength of the fishing rod by easing the stress concentration. As the film 19 is formed such that it is drawn in up to the rear end of the reinforced tubular body 17 drawn into the synthetic resin seat body 16, the external appearance of the synthetic resin seat body 16 is improvable when the synthetic resin seat body 16 is made transparent. Moreover, its excellent external appearance can be maintained for a long term.

As in the case of the above-described embodiment of the invention, though the front end of the reinforced tubular body 17 in its long direction is made longer than the synthetic resin seat body 16, the front end thereof may be made shorter than the front end portion of the synthetic resin seat body 16.

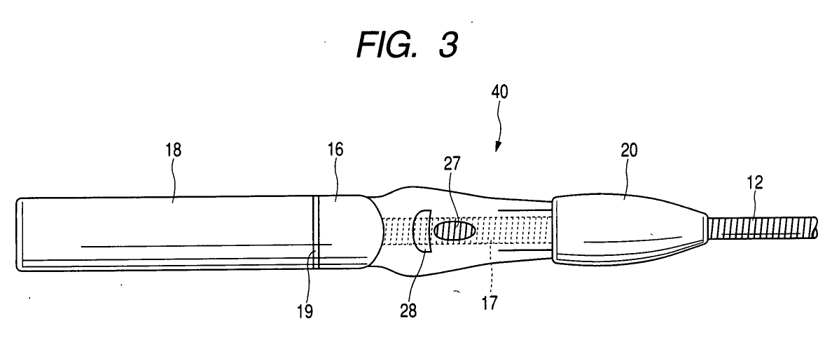

FIG. 3 shows a fishing rod as another modified example of the above-described embodiment of the invention. The reinforced tubular body 17 of a fishing rod 40 in this modified example is made of fiber-reinforced synthetic resins and by leaving the trace of a tape wound in a secure manner on the outer peripheral face of the reinforced tubular body 17 at the time of molding with the trace as a pattern, the pattern is made visually confirmable from the outside of the transparent synthetic resin seat body 16. Consequently, not only a profound external appearance is obtained but a excellent external appearance is maintainable for a long term. Further, the external appearance (design) of the reinforced tubular body 17 through the transparent reinforced tubular body 17 can be approximated with the external appearance of the fiber-reinforced synthetic resin rod pipe 12, whereby it is possible to make the external appearance a design having a feeling of identification from the rod pipe 12 up to the reinforced tubular body 17. The pattern attached to the outer surface of the reinforced tubular body 17 can be provided with any given design. As the rest of the arrangement other than the aforementioned is basically similar to the first embodiment of the invention, the detailed description thereof will be omitted.

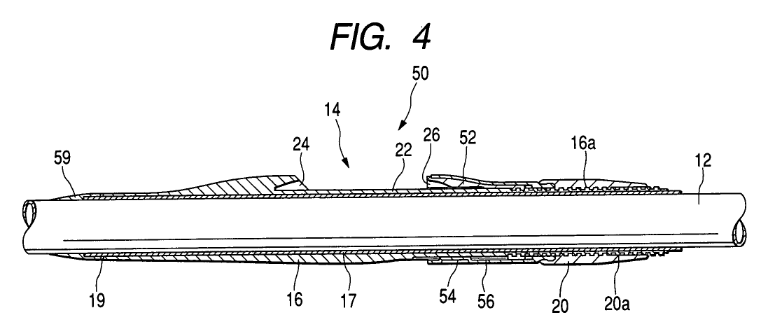

FIG. 4 shows a fishing rod as still another modified example of the above-described embodiment of the invention. A fishing rod 50 in this modified example is an embodiment in which the invention is applied to a tubular reel seat. The handle portion 14 having the tubular reel seat is provided in the rod seat portion of the fiber-reinforced synthetic resin rod pipe 12. The handle portion 14 is formed integrally with a substantially tubular seat body 16 as a body member outside the reinforced tubular body 17 covering and fitted to the rod pipe 12. The seat body 16 is integrated with the reinforced tubular body 17 and the reinforced tubular body 17 is fixedly adhered to the outer side of the rod pipe 12 with an adhesive agent.

The reinforced tubular body 17 is formed longer than the whole length of the seat body 16 and both front and rear ends of the reinforced tubular body 17 are jutted out of the respective front and rear ends of the seat body 16. The reel leg placing-holding portion 22 for placing and holding the reel mounting leg portion (not shown) is formed in the intermediate portion of the seat body 16.

The opening 24 opened toward the rod tip portion is provided in one end portion of the seat body 16 to receive and latch one leg portion of the reel mounting leg portion (not shown), the one portion thereof being used to form the fixed hood. The threaded portion 16a is formed in the outer periphery of the front-end-side portion of the seat body 16 and mated with the cylindrical front grip portion (nut). The threaded portion 20a mating with the threaded portion 16a of the seat body 16 is formed on the inner surface of the front grip portion 20. The front grip portion 20 is made movable along the axial direction on the seat body 16 by turning the front grip portion 20.

A moving hood 52 is rotatably coupled to the front grip portion 20. The opening 26 for receiving and latching the other leg portion of the reel mounting leg portion (not shown) is formed in the moving hood 52. Further, a protruded portion 54 is formed on the inner surface of the moving hood 52 and a groove 56 is formed in the seat body 16. Then the protruded portion 54 is mated with the groove 56 whereby to prevent the moving hood 53 from turning.

Incidentally, the rod pipe 12, the seat body 16 and reinforced tubular body 17 are formed of the same material, manufactured and assembled in the same method as what is described in the above-described embodiment of the invention.

The reinforced tubular body 17 is passed through the front grip portion 20 and apparently projected out of the front grip portion 20. The opposite side end portion of the reinforced tubular body 17 is also projected from the end of the seat body 16 and the film 19 having concealing properties is formed at the projected end. Moreover, the projected portions is painted with synthetic resin 59 or subjected to padding so as to form an outer peripheral face gently continuing from the seat body 16. Consequently, the external appearance in the vicinity of the end portion of the reinforced tubular body 17 can be improved and the external appearance therein is improved particularly when the transparent synthetic resin seat body 16 is employed.

Although the end of the reinforced tubular body 17 becomes projected from the end of the seat body 16 in this modified example, the end of the reinforced tubular body 17 may be drawn out of the end of the seat body 16 in order to shorten the reinforced tubular body 17.

The invention is not limited to the embodiment thereof as described above but may be modified in various manners. Although the invention has been applied to the reel seat according to the above-described embodiment thereof, the invention may be applied to not only the reel seat of the fishing rod but the grip portion, for example.

As set forth above, the fishing rod provided according to the invention makes realizable improving and stabilizing the strength of mounting the parts fixed to the rod pipe, and reducing the weight and size of the portion to which the parts are mounted as well as achieving excellence in its external appearance.

As set forth above, the fishing rod provided according to the invention makes realizable improving and stabilizing the strength of mounting the parts fixed to the rod pipe, and reducing the weight and size of the portion to which the parts are mounted as well as achieving excellence in its external appearance.

What is claimed is:

1. A fishing rod comprising:
a rod pipe;
a tubular body to which the rod pipe is inserted and fitted;
a tubular transparent synthetic resin body integrally molded with the tubular body; and
a concealing film formed at least one edge face portion of the synthetic resin body.

2. The fishing rod according to claim 1, wherein the tubular body is formed by winding fiber-reinforced prepreg prepared by impregnating reinforced fiber with synthetic resin, and an outer peripheral surface of the tubular body is visually confirmable from an outside of the synthetic resin body.

3. The fishing rod according to claim 2 further comprising a cover member provided for covering a portion of the synthetic resin body where the concealing film is formed.

4. The fishing rod according to claim 1, wherein the synthetic resin body includes an opening to which a leg of a reel is adapted to be inserted.

5. The fishing rod according to claim 1, wherein a plane of the concealing film is inclined with respect to the tubular body.

6. A method of manufacturing a fishing rod comprising the steps of:
molding a tubular transparent synthetic resin body integrally with a tubular body;
forming a concealing film on at least one edge face portion of the synthetic resin body; and
inserting and fitting a rod pipe to the tubular body with which the synthetic resin body is integrally formed.

7. A fishing reel comprising:
a rod pipe;
a reinforced tubular body to which the rod pipe is inserted and fitted; and
a synthetic resin body which is integrally molded with an outer side of the tubular body, includes a portion larger in thickness than the tubular body and is made of a material softer than that of the tubular body.

8. The fishing reel according to claim 7, wherein one end of the reinforced tubular body is projected from one edge face of the synthetic resin body in an axial direction of the tubular body.

9. The fishing reel according to claim 7, wherein one end of the reinforced tubular body is located inside the synthetic resin body.

10. The fishing rod according to claim 7, wherein the reinforced tubular body is formed by winding fiber-reinforced prepreg prepared by impregnating reinforced fiber with synthetic resin.

11. The fishing rod according to claim 7 further comprising a member formed of soft material equal to or greater in softness than the material of the synthetic resin body which is disposed from one edge face of the synthetic resin body over an outer periphery of the rod pipe.

12. The fishing rod according to claims 7 further comprising a concealing film formed in an end portion of the synthetic resin body; and a cover member for covering the film, wherein the synthetic resin body is made of a translucent material.

13. The fishing rod according to claim 7, wherein the synthetic resin body includes an opening to which a leg of a reel is adapted to be inserted.

14. A method of manufacturing a fishing rod comprising the steps of:
molding a synthetic resin body integrally with a tubular body so that a portion of the synthetic resin body is larger in thickness than the tubular body, the synthetic resin body being made of a material softer than that of the tubular body; and
inserting and fitting a rod pipe to the tubular body with which the synthetic resin body is integrally formed.
